(19) United States
(12) Patent Application Publication
(10) Pub. No.: US 2026/0357710 A1
(43) Pub. Date: Nov. 12, 2026

(54) TURBINE GENERATOR ASSEMBLY

(71) Applicant: MITIS, Hannut (BE)

(72) Inventors: Michel Delanaye, Hannut (BE); Jean-Michel Teney, Liège (BE)

(73) Assignee: MITIS, Hannut (BE)

(21) Appl. No.: 19/111,957

(22) PCT Filed: Oct. 20, 2023
(86) PCT No.: PCT/EP2023/079372

§ 371 Date: Mar. 14, 2025

(30) Foreign Application Priority Data
Oct. 21, 2022 (BE) BE2022/5849

(51) Int. Cl. F01D 15/10; H02K 7/18

(52) U.S. Cl. CPC F01D 15/10; H02K 7/1823; F05D 2220/76

(57) ABSTRACT

A turbine generator assembly for a power generation unit or energy cogeneration unit. The turbine generator assembly includes, axially aligned and in the order indicated: a turbine, a first radial bearing, a compressor a second radial bearing, and a motor-generator.

### TECHNICAL FIELD

The present invention relates to an assembly which forms part of a turbine generator and is intended for use in a power generation unit or energy cogeneration unit.

### BACKGROUND

Known power generation unit or energy cogeneration unit include a combustion device supplying combustion gases to a turbine mechanically coupled to a compressor that compresses the air injected into the combustion device. Such an device is described, for example, in the document WO2022089822A1.

The mechanical coupling between the turbine and the compressor is via a central element, supported in rotation by radial bearings. The documents U.S. Pat No. 6,305,169 B1, US 2003/223892 A1 and DE 20 2006 004 975 U1 disclose such mechanical couplings. The correct positioning of these bearings is essential to achieve excellent stability, particularly at high rotation speed.

### DISCLOSURE OF THE INVENTION

One of the aims of the invention is to provide a turbine generator assembly for a power generation unit or energy cogeneration unit comprising a turbine and a compressor which is particularly mechanically stable. To this end, the invention proposes a turbine generator assembly comprising:
a turbine configured to be supplied with combustion gases by a combustion device;
a compressor mechanically coupled to the turbine by a central element;
a motor-generator axially offset from the compressor and mechanically coupled to the turbine and the compressor by the central element;
a first radial bearing located axially between the turbine and the compressor and designed to guide the central element in rotation; and
a second radial bearing, located axially between the compressor and the motor-generator, and designed to guide the central element in rotation.

The first radial bearing is the only radial bearing between the turbine and the compressor.

In the turbine generator assembly according to the invention, the radial bearings are located axially on either side of the compressor: the first bearing is located between the turbine and the compressor, and the second bearing is located between the compressor and the motor-generator. Such a distribution of radial bearings allows us to take up the moments of force in a particularly effective way because these moments come from the masses of the turbine, the compressor and the rotor of the motor-generator (the latter being particularly heavy). It therefore allows the number of radial bearings to be limited.

As the first radial bearing is the only radial bearing between the turbine and the compressor, there is no other radial bearing than the first radial bearing between the turbine and the compressor. This allows the distance between the turbine and the compressor to be reduced, thus improving system stability.

In addition, the position of the second bearing, on the other side of the compressor from the turbine, reduces the distance between the turbine and the compressor, provides better ventilation of the region between the turbine and the compressor, which is very hot, and therefore improves system stability.

The system is designed to rotate preferably at a speed of at least 80,000 rpm, more preferably at least 100,000 rpm. For example, it can be designed to run at between 90,000 and 150,000 revolutions per minute.

As is known to a person skilled in the art, the “motor-generator” functions as a motor when it is supplied with electrical energy and provides the energy in the form of movement, and as a generator when it is supplied with energy in the form of movement and provides the electrical energy. Alternatively, the term “motor-generator” may be replaced in this document by “motor and/or generator”. The motor-generator is an electric motor-generator comprising a rotor and a stator. The rotor of the motor-generator is formed by a part of the central element to which a rotor magnet device is attached. The rotor magnet device comprises one or more magnets, preferably permanent magnets.

For the purposes of this document, a “radial” bearing is a bearing preventing movement perpendicular to the axis of rotation, and an “axial” bearing is a bearing preventing movement parallel to the axis of rotation. The radial bearings can be separated radially from the central element by another rotating element attached to the central element.

For the purposes of this document, a radial bearing is an aerodynamic bearing. During rotation, the central element levitates, separated from the bearing by a layer of air that supports the bearing by a lift effect. This is not a rolling bearing. It requires no lubrication.

In one embodiment, the turbine generator assembly comprises an air pipe leading to the compressor, the air pipe being located between the compressor and the second radial bearing and having a radial component.

Instead of an axial air pipe located between the rotor and the stator, it is preferred that the air pipe is located between the second radial bearing and the compressor and is not parallel to the axis (in other words, it has a radial component). This allows the distance between the rotor and stator is particularly small, which improves the electro-magnetic-mechanical stability of the system and reduces reactive power, while improving the angular phase shift (cosine φ). The air pipe may comprise one or more bends, comprise a radial section and/or comprise an inlet scroll that takes in air from the side and spirals it at a specific angle.

In one embodiment, the first radial bearing and the second radial bearing are foil bearings.

The foil bearings allow the use of a central element with a larger diameter than other bearings, such as ball bearings, would allow. This allows the first natural frequency of bending to be increased, improving stability and high-speed operation.

According to one embodiment, the central element is made of a single piece or of a plurality of pieces attached together so as to rotate integrally.

The central element, which extends from the turbine through the compressor to the motor-generator, therefore has a rotational speed that is identical over its entire length. A central element made of one piece or made of integrally attached parts simplifies the balancing procedure, which is particularly delicate in a turbine generator assembly such as that of the invention.

According to one embodiment, the first radial bearing and the second radial bearing are the only radial bearings.

There is therefore no other radial bearing, either beyond the motor-generator in relation to the compressor, or between the motor-generator and the turbine, or beyond the turbine in relation to the compressor. As the turbine generator assembly described here rotates particularly quickly, the issue of concentricity is an important one. The smaller the number of bearings, the easier it is for them all to be concentric. Having two bearings is an interesting compromise between the constraints of stability and concentricity.

According to one embodiment, the turbine generator assembly comprises an abutment and an axial bearing configured to prevent an axial movement of the abutment.

The abutment, which may be called an axial abutment, is preferably located between the turbine and the compressor. It is attached, directly or indirectly, to the central element.

According to one embodiment, the turbine generator assembly comprises a shaft releasably attached to the central element such that the shaft and central element rotate together, the abutment forming part of the shaft. The shaft could also be called a “rotating element”. The presence of the shaft, forming a separate part from the central element, allows the radial bearings, the compressor and the turbine to be threaded onto the central element.

According to one embodiment, the motor-generator comprises a rotor attached to the central element and comprising a bipole rotor magnet device, preferably with permanent magnet(s).

In other words, the rotor magnet device comprises only one south pole and one north pole. Given the very high speed of rotation, the assembly is easier to straighten than with a quadrupole or with more magnetic poles. This can be a single permanent magnet.

According to one embodiment, the motor-generator comprises a rotor attached to the central element and comprising a rotor magnet device located inside the central element.

This allows the rotor magnet device, which is particularly heavy, to be close to the axis. It is possible, however, while remaining within the scope of the invention, for the rotor magnet device to be attached outside the central element, for example shrunk onto the central element.

According one embodiment, the central element comprises a cavity having an opening in a radial plane and located at one end of the central element, the rotor magnet device being located in the cavity.

The opening allows the rotor magnet device to be inserted into the central element, centring it with particular precision.

According to an embodiment, the turbine generator assembly comprises a central element angular position detector, which comprises:
a target attached to one end of the central element, and
an inductive sensor stationary relative to a stator of the motor-generator.

The angular position detector can also be used to determine the speed of rotation of the central element. The inductive sensor is preferably aligned on the axis, facing the target. It is preferably connected to an electronic device supported by an ogive-shaped casing.

The person skilled in the art will readily understand that the considerations in this document relating to the angular position detector go beyond the strict scope of the invention as claimed and could be the subject of an invention in its own right, in particular in the general context of a turbine generator assembly provided with a turbine, a compressor and a motor-generator or generator as aforesaid, including in the case where the radial shields are absent or in a different number and/or arranged in a manner other than that described in this document.

In one embodiment, the target comprises an insulating surface and a metallic radial element.

The metal radial element is the reference point for the inductive sensor.

In one embodiment, the central element has a diameter greater than 15 mm and less than 40 mm.

The diameter of the central element can vary depending on the position along the axis, but preferably nowhere is it less than 15 mm or more than 40 mm. A small diameter allows the value of the first bending natural frequency to be reduced, which reduces stability and high-speed operation. A large diameter reduces the efficiency of the turbine generator assembly. The interval claimed is a compromise between these two constraints.

The invention also provides a power generation unit or an energy cogeneration unit comprising a turbine generator assembly according to the invention. Preferably, the only radial bearings are the first radial bearing and the second radial bearing.

### BRIEF DESCRIPTION OF THE FIGURES

Further characteristics and advantages of the invention will become apparent from the following detailed description, for the understanding of which reference is made to the appended figures, among which:

FIG. 1 is a schematic diagram of a power generation unit or an energy cogeneration unit;

FIG. 2 is an axial section of a part of a turbine generator assembly,

FIG. 3 is an axial section of a part of another turbine generator assembly,

FIG. 4 is an axial section of the turbine generator assembly partly illustrated in FIG. 2, and

FIG. 5 is a front view of a target.

### EMBODIMENTS OF THE INVENTION

The present invention is described with particular embodiments and references to figures but the invention is not limited thereby. The drawings or figures described are schematic only and are not limiting. Furthermore, the functions described may be carried out by structures other than those described in this document.

In the figures, identical or similar elements may have the same references. Reference numbers in the claims do not limit their scope.

In this document, the terms “first” and “second” are used to differentiate between the various elements and do not imply any order between these elements. In this document, the use of the verbs “include”, “comprise”, or any other variant, as well as their conjugations, cannot exclude the presence of elements other than those mentioned. Similarly, in this document, the use of an indefinite article “a”, “an” and/or a definite article “the” to introduce an element does not exclude the presence of a plurality of these elements.

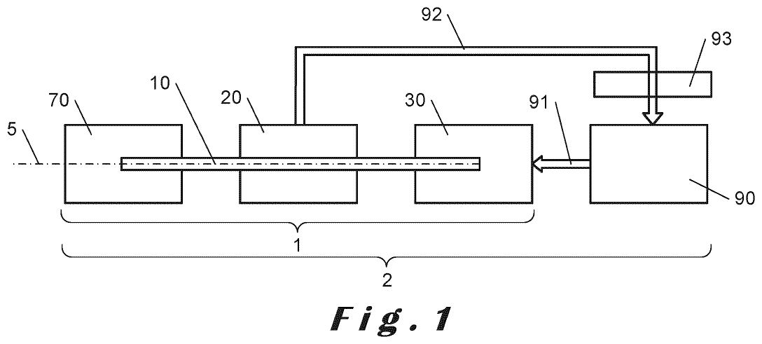

FIG. 1 schematically illustrates various elements of a power generation unit or an energy cogeneration unit 2. The device 2 comprises a combustion device 90, a turbine 30, a compressor 20 and a motor-generator 70. The combustion device 90 transmits combustion gases (i.e. resulting from combustion) to the turbine 30 via a first duct 91. The turbine 30, the compressor 20 and the motor-generator 70 are mechanically coupled via a central element 10. The air compressed by the compressor 20 is sent to the combustion device 90 via a second duct 92 and a recuperator 93 which preheats the compressed air before injecting it into the combustion device 90. The compressor 20 is preferably shrunk onto the central element 10.

In the context of the present document, a turbine generator assembly 1 comprises the turbine 30, the compressor 20, the motor-generator 70 and the central element 10, which are aligned for rotation about the axis 5. It is connected to the combustion device 90. The turbine 30, the compressor 20 and the motor-generator 70 are arranged axially in the following order: turbine 30, compressor 20, motor-generator 70, so as to be axially distant from each other.

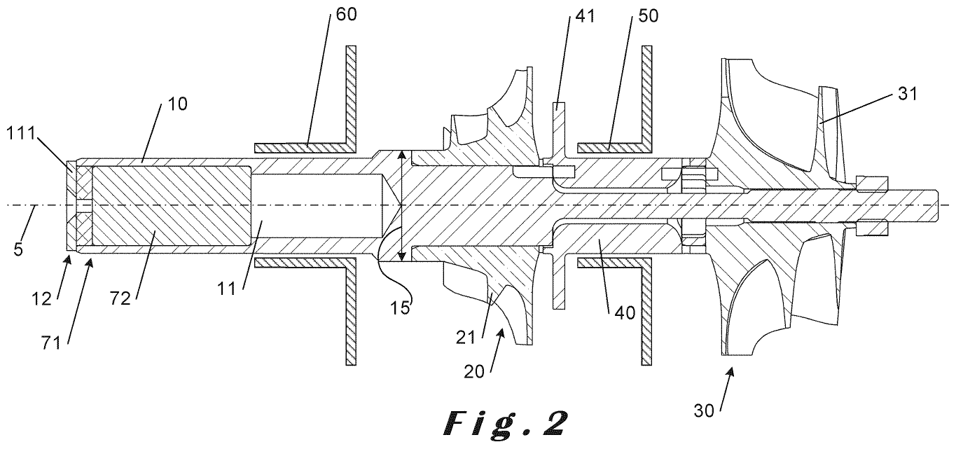

FIG. 2 illustrates some parts of a turbine generator assembly 1. It shows in particular the blades 31 of the turbine 30, the blades 21 of the compressor 20, and a rotor magnet device 72 of the rotor 71 of the motor-generator 70.

The turbine 30 and the compressor 20 are separated axially by a first radial bearing 50, which radially surrounds the central element 10. The first radial bearing 50 is preferably the only radial bearing between the turbine 30 and the compressor 20.

The compressor 20 and the motor-generator 70 are separated axially by a second radial bearing 60, which radially surrounds the central element 10. In particular, the second radial bearing 60 separates the compressor axially from the rotor magnet device 72. The second radial bearing 60 is preferably the only radial bearing between the compressor 20 and the motor-generator 70.

The first radial bearing 50 and the second radial bearing 60 are preferably foil bearings. The first radial bearing 50 and the second radial bearing 60 are preferably the only radial bearings in the turbine generator assembly 1 and the power generation unit or energy cogeneration unit 2.

Preferably, the central element 10 is made from a single piece or from a plurality of pieces attached together so that they all rotate at the same angular speed, as if they were one piece.

Preferably, the radial diameter 15 of the central element, whatever the position of along the axis 5, is greater than 15 mm and/or less than 40 mm.

Preferably, the central element 10 is attached to a shaft 40 which surrounds it radially, and the first radial bearing 50 surrounds the shaft 40 radially. The shaft 40 is located axially between the turbine 30 and the compressor 20. The shaft 40 comprises an axial abutment 41 held by an axial bearing 81 (visible in FIG. 4). The abutment 41 is such that the diameter 15 of the central element 10, at any point, is smaller than the diameter of the abutment 41.

The rotor magnet device 72 is preferably a bipole, for example a magnet. In the embodiment shown in FIG. 2, it is located in a cavity 11 inside the central element 10. The cavity 11 preferably comprises an opening leading axially onto the end 12 of the central element 10.

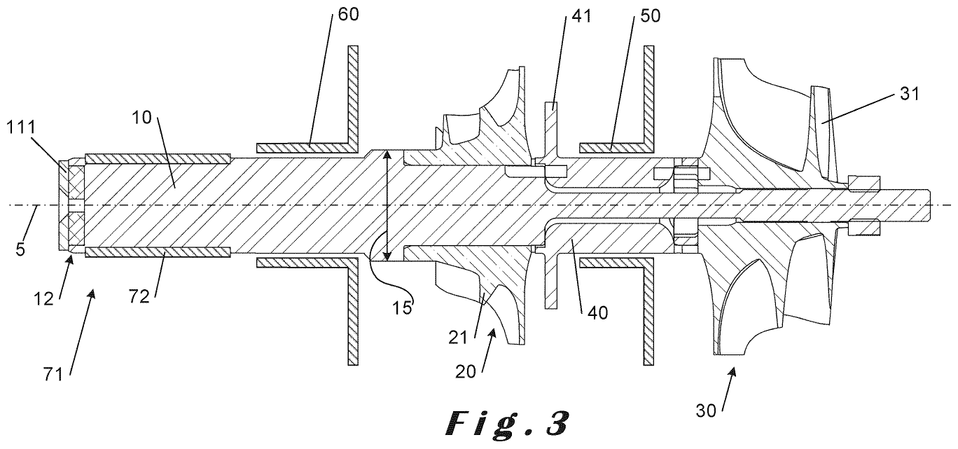

In the embodiment shown in FIG. 3, the rotor magnet device 72 is attached to the outside of the central element 10, so as to surround it radially.

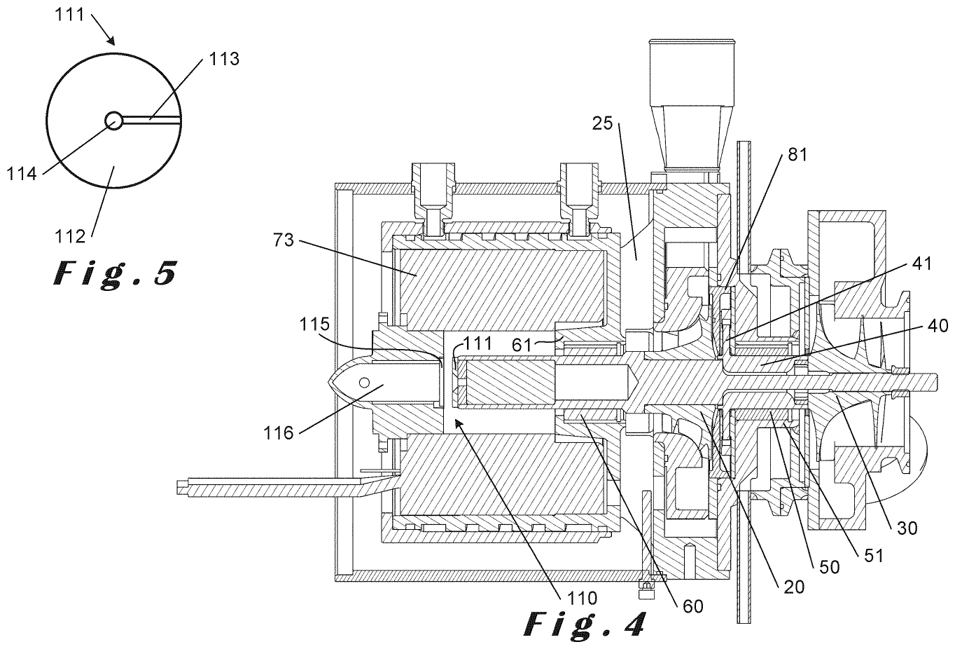

FIGS. 2 and 3 also illustrate a 111 target, which will be described in more detail with reference to FIGS. 4 and 5.

FIG. 4 illustrates some parts of a turbine generator assembly 1. The turbine generator assembly 1 comprises an air pipe 25 supplying air to the compressor 20. The air pipe 25 is preferably located between the compressor 20 and the second radial bearing 60. It has a radial component, i.e. the path of the air in this air pipe 25 is not solely axial.

The turbine generator assembly 1 preferably comprises a first bearing support 51 around the first radial bearing 50 and a second bearing support 61 around the second radial bearing 60. The first 51 and second 61 bearing supports are stationary relative to each other and are concentric. The first 51 and second 61 bearing supports are stationary relative to a stator 73 of the motor-generator 70.

The turbine generator assembly 1 preferably comprises a detector 110 for determining the angular position of the central element 10 and preferably the angular velocity of the central element 10. The detector 110 comprises a target 111 attached to the end 12 of the central element 10 in a radial plane. It rotates with the central element 10 while remaining in the same plane. The detector 110 also comprises an inductive sensor 115 axially aligned with the target 111, and stationary relative to the stator 73 of the motor-generator 70. It is connected to an electronic device comprising a card for acquiring angular velocity and/or position which is supported by an ogival-shaped casing 116. On the basis of the angular position and/or angular velocity measurement, the electronic device allows control and/or monitoring of the turbine generator assembly 1 during operation, thus allowing stall prevention.

FIG. 5 illustrates target 111 in one embodiment of the invention. It consists of an insulating surface 112 and a metal radial element 113. It is preferably pierced by an axial hole 114.

In summary, the invention relates to a turbine generator assembly 1 for a power generation unit or energy cogeneration unit. The turbine generator assembly 1 comprises, axially aligned and in this order: a turbine 30, a first radial bearing 50, a compressor 20, a second radial bearing 60, and a motor-generator 70.

The present invention has been described above in connection with specific embodiments, which are illustrative and should not be considered limiting. It will be readily apparent to the person skilled in the art that the invention is not limited to the examples illustrated or described above, and that its scope is more broadly defined by the claims hereinafter introduced.

1. A turbine generator assembly comprising:
a turbine configured to be supplied with combustion gases by a combustion device;
a compressor mechanically coupled to the turbine by a central element;
a motor-generator axially offset from the compressor and mechanically coupled to the turbine and the compressor by the central element;
a first radial bearing located axially between the turbine and the compressor and designed to guide the central element in rotation; and
a second radial bearing located axially between the compressor and the motor-generator and designed to guide the central element in rotation,
wherein the first radial bearing is the only radial bearing between the turbine and the compressor.

2. The turbine generator assembly according to claim 1, comprising an air pipe leading to the compressor, the air pipe being located between the compressor and the second radial bearing and having a radial component.

3. The turbine generator assembly according to claim 1, wherein the first radial bearing and the second radial bearing are foil bearings.

4. The turbine generator assembly according to claim 1, wherein the central element is made of a single piece or of a plurality of pieces attached together so as to rotate integrally.

5. The turbine generator assembly according to Claim 1, wherein the first radial bearing and the second radial bearing are the only radial bearings of the turbine generator assembly.

6. The turbine generator assembly according to claim 1, comprising an abutment and an axial bearing configured to prevent axial movement of the abutment.

7. The turbine generator assembly according to claim 6, comprising a shaft releasably attached to the central element such that the shaft and central element rotate together, the abutment forming part of the shaft.

8. The turbine generator assembly according to claim 1, wherein the motor-generator comprises a rotor attached to the central element and comprising a bipolar rotor magnet device.

9. The turbine generator assembly according to claim 1, wherein the motor-generator comprises a rotor attached to the central element and comprising a rotor magnet device located inside the central element.

10. The turbine generator assembly according to claim 9, wherein the central element comprises a cavity having an opening in a radial plane and located at one end of the central element, the rotor magnet device being located in the cavity.

11. The turbine generator assembly according to claim 1, further comprising an angular position detector of the central element which comprises:
a target attached to one end of the central element, and
an inductive sensor stationary relative to a stator of the motor-generator.

12. The turbine generator assembly according to claim 11, wherein the target includes an insulating surface and a metallic radial element.

13. The turbine generator assembly according to claim 1, wherein the central element has a diameter greater than 15 mm and less than 40 mm.

14. A power generation unit or energy cogeneration unit comprising a turbine generator assembly according to claim 1.
